(19) United States
(12) Patent Application Publication
(10) Pub. No.: US 2026/0009885 A1
(43) Pub. Date: Jan. 8, 2026

(54) METHOD FOR TRACKING AND TRACING A TARGET IN AN ENVIRONMENT

(71) Applicant: Robert Bosch GmbH, Stuttgart (DE)

(72) Inventors: Guillaume Jornod, Bern (CH); Maximilian Stark, Hamburg (DE)

(21) Appl. No.: 19/234,377

(22) Filed: Jun. 11, 2025

(30) Foreign Application Priority Data
Jul. 3, 2024 (DE) 10 2024 206 259.6

(51) Int. Cl. G01S 7/41; G01S 13/06; G06K 19/07

(52) U.S. Cl. CPC G01S 7/411; G01S 13/06; G06K 19/0723

(57) ABSTRACT

A method for tracking and tracing a target in an environment. The method including the following steps performed by a distributed ISAC system: receiving a request for tracking and tracing the target in the environment from a requesting entity; initiating a sensing task by at least one local node via forwarding the received request, wherein the performance of the sensing task includes transmitting a sensing signal; estimating, by the local node, a size of an obstacle in front of the target depending on a distortion of a reflected sensing signal of the transmitted sensing signal caused by the obstacle in front of the target in the environment; assessing, by the local node, a position and a size of the target based on reflections of the sensing signal and based on the distortion of the reflected signal caused by the obstacle in front of the target.

### CROSS REFERENCE

The present application claims the benefit under 35 U.S.C. § 119 of German Patent Application No. DE 10 2024 206 259.6 filed on Jul. 3, 2024, which is expressly incorporated herein by reference in its entirety.

### FIELD

The present invention relates to a method for tracking and tracing a target in an environment. Furthermore, the present invention relates to a computer program, a system, a central and a local node for this purpose.

### BACKGROUND INFORMATION

The field of distributed sensing and communication systems has seen significant advancements in recent years, with various approaches being explored to leverage existing communication infrastructure for sensing purposes. One promising direction is the use of radio waves from base stations capable of sensing, also known as Integrated Sensing and Communication (ISAC) signals. ISAC signals have been shown to be effective in enabling distributed sensing and monitoring applications, such as environmental monitoring and industrial automation.

However, current systems relying on ISAC signals often struggle with signal distortions and attenuations caused by obstacles or materials, which can degrade the quality of the received data. To address this limitation, researchers have turned to ground truth information, obtained through reference sensors or external sources, to adaptively adjust equalizer parameters and improve signal quality.

Despite these advancements, there remains a need for more robust and reliable track-and-trace solutions that can effectively navigate complex environments and overcome obstacles such as shadowing.

### SUMMARY

According to aspects of the present invention, a method, a central node, a local node, a system, and a computer program are provided. Features and details of the present invention are disclosed herein. Features and details described in the context to the method of the present invention also correspond to the computer program of the present invention, the nodes of the present invention, as well as the system of the present invention, and vice versa in each case.

According to an aspect of the present invention, a method for tracking and tracing a target in an environment is provided. According to an example embodiment of the present invention, the method comprises the following steps performed by a distributed ISAC system:
Receiving at a central node of the distributed ISAC system a request for tracking and tracing the target in the environment from a requesting entity,
Initiating a performance of a sensing task by at least one local node of the ISAC system via forwarding the received request from the central node to the at least one local node, wherein the performance of the sensing task includes transmitting a sensing signal,
Estimating, by the at least one local node, a size of an obstacle in front of the target depending on a distortion of a reflected sensing signal of the transmitted sensing signal caused by the obstacle in front of the target in the environment,
Assessing, by the at least one local node, a position and a size of the target based on reflections of sensing signals and based on the distortion of the reflected signal caused by the obstacle in front of the target,
Transmitting a report of the respective assessed size of the obstacle and the respective assessed position of the target from the at least one local node to the central node,
Fusing, by the central node, the respective report received from the at least one local node to determine the actual location of the target and the actual size of the obstacle,
Sending the respective result of the fusing (106) via a report to the requesting entity for tracking and tracing the target.

Here, the reflected sensing signal is generated by an reflection of the transmitted sensing signal caused by the obstacle in front of the target in the environment.

This has the advantage that the method of the present invention enables a cost-effective and scalable solution for collecting data from the environment or monitoring specific parameters by the use of radio waves as “X-rays”. This usage enables to perceive the depth of obstructing objects or the width of attenuating material in front of the receiver allows for the location of a target to be made possible. The system's ability to estimate the size of obstacles and position of targets based on reflected sensing signals and distortions caused by these obstacles advantageously enables accurate tracking and tracing of static or movable targets in various domains, including environmental monitoring or industrial automation. Further, this allows to significantly improve the field of track and trace technology. Furthermore, the method of the present invention allows to estimate the size of obstacles and position of targets based on reflected sensing signals and distortions caused by these obstacles enabling accurate tracking and tracing of targets.

According to an example embodiment of the present invention, it is further possible that the target comprises a radio tag, wherein the radio tag reflects a signal in case of receiving a sensing signal.

According to an example embodiment of the present invention, it is possible that the target may comprise a radio tag, which can reflect a signal upon receiving a sensing signal. This allows for the identification of targets or tags and further has the advantage to enable an estimation of obstacle width as well as target position through the analysis of reflected signals. The presence of a radio tag on the target enables the use of radio waves to perceive the depth of obstructing objects or the width of attenuating material, thereby facilitating the tracking and tracing process. Further, by optionally incorporating machine learning algorithms into the signal processing framework, it may be possible to develop predictive models that forecast changes in environmental conditions or anticipate potential disruptions.

According to an example embodiment of the present invention, it is possible that the method steps are carried out iteratively in case of a moving target, wherein the method comprises the further following step:
Sending a position report from the central node to the requesting entity regularly, specifically at defined time points and/or time intervals.

According to an example embodiment of the present invention, it is possible that the iterative execution of the method steps becomes necessary when tracking a moving target. In such cases, the method may comprise an additional step where the central node sends regular position reports to the requesting entity, thereby enabling real-time monitoring and updating of the target's location. This feature allows for more accurate and timely tracking of the target, particularly in scenarios where the target is dynamic or exhibits unpredictable movements. Further, the method could be optimized for real-time performance by utilizing cloud-based processing and distributed computing architectures, enabling the system to scale up or down according to the demands of the tracking task.

Furthermore, incorporating advanced sensing modalities, such as lidar, radar, or thermal imaging, could enhance the system's ability to detect and track targets in various environments and conditions, including poor visibility, heavy rain, or smoke-filled areas.

According to an example embodiment of the present invention, it is further possible that after the receiving the method comprises the further following step:
Forwarding the request to at least one local node in the environment of the target.

According to an example embodiment of the present invention, it is possible that upon receiving a request for tracking and tracing a target in an environment, the central node may forward the request to at least one local node in the environment of the target. This additional step enables the local nodes to initiate their sensing tasks, which can lead to more accurate estimations of obstacle sizes and target positions. The forwarded request allows the local nodes to perform their respective tasks, thereby enhancing the overall tracking and tracing capabilities of the DISAC system. Further, it is possible that by leveraging the distributed nature of the system of the present invention, the method of the present invention can be further enhanced to enable real-time adaptation and learning from the environment. This can be achieved through a feedback loop mechanism, where the central node receives and processes the reports from individual ISAC nodes and uses this information to update and refine its understanding of the environment. For example, as the system is tracking and tracing targets in the environment, it can continually collect and analyze data on obstacle sizes and target positions. This information can be advantageously used to refine the signal equalization techniques employed by the ISAC nodes, allowing for more accurate estimates of obstacle widths and target locations.

According to an example embodiment of the present invention, it is possible that during the initiating the method comprises at least one of the further following steps:
Sending the sensing signal to the target in the environment,
Receiving the reflection of the sensing signal from the target.

According to an example embodiment of the present invention, it is possible that during the initiating step of the method according to the present invention, the at least one local node may send a sensing signal to the target in the environment and receive a reflection of the sensing signal from the target. This step allows for the estimation of the position of the target and the size of any obstacles in front of it, which is crucial for tracking and tracing purposes. The reception of the reflection of the sensing signal advantageously provides valuable information about the target's location and the presence of obstacles, enabling the local node to accurately estimate the target's position and the size of the obstacles.

In industrial automation, the approach could facilitate real-time monitoring and tracking of materials, components, or products in manufacturing processes, enabling just-in-time production and optimized supply chain management. This would lead to improved quality control, reduced waste, and increased efficiency.

According to an example embodiment of the present invention, it is further possible that the central node comprises a Sensing Management Function of a communications network and wherein the at least one local node comprises a base station of the communications network.

According to an example embodiment of the present invention, it is possible that the central node comprises a Sensing Management Function of a communications network, which enables efficient management of sensing tasks and coordination with individual ISAC nodes. This allows for optimal utilization of resources and ensures seamless communication among nodes in the system of the present invention. Further, each local node can leverage its existing infrastructure to transmit and receive signals, streamlining the process and reducing complexity. Furthermore, this allows to enable a seamless integration of sensing capabilities into existing infrastructure, allowing for a more comprehensive understanding of the environment. By leveraging the power of radio waves and signal processing, this technology can provide real-time insights into the presence and movement of objects, even in complex or dynamic environments.

In another aspect of the present invention a central node for tracking and tracing a target in an environment is provided the central node comprising means for receiving the transmitted report from the at least one local node, wherein the central node is adapted to perform steps of receiving, initiating, fusing, and sending.

Thus, the central node according to the present invention brings the same advantages as have been described in detail with reference to the method according to the present invention.

Optionally, the central node can be adapted to optimize the tracking process by processing the received reports, thereby enhancing the overall accuracy and efficiency of the target tracking operation. This optimization can be achieved through advanced algorithms that utilize machine learning techniques, such as neural networks or decision trees, to analyze the data and make predictions about the target's movement.

In another example, the central node can comprise a user-friendly interface that allows users to visualize the tracking results in real-time, enabling them to make informed decisions based on the updated information. This interface can comprise features such as 3D visualizations, heat maps, or graphs that illustrate the target's movement over time, providing valuable insights for applications like environmental monitoring or industrial automation.

Another aspect of the present invention is a local node for tracking and tracing a target in an environment, wherein the local node is adapted to perform steps of estimating and assessing and wherein the local node comprises means for transmitting a report to a central node. Thus, the local node according to the present invention brings the same advantages as have been described in detail with reference to the method according to the present invention.

Another aspect of the present invention is a system for tracking and tracing a target in an environment comprising a central node according to the present invention and at least one local node according to the present invention.

Thus, the system according to the present invention brings the same advantages as have been described in detail with reference to the method according to the present invention.

Another aspect of the present invention is a computer program, in particular a computer program product, comprising instructions which, wherein when the program is executed by a computer of a local node, cause the computer to execute steps of estimating, assessing and to transmit a report to a computer of a central node. Thus, the computer according to the present invention brings the same advantages as have been described in detail with reference to the method according to the present invention.

In another aspect of the present invention, an apparatus for data processing may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention, a computer-readable storage medium may be provided which comprises the computer program according to the present invention and/or instructions which, when executed by a computer, cause the computer to carry out the steps of the method according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be implemented as a computer-implemented method. Alternatively, or additionally, at least one of the disclosed method steps may be computer-implemented and/or automated.

Further advantages, features and details of the present invention will be apparent from the following description, in which embodiments of the present invention are described in detail with reference to the figures. In this context, the features mentioned herein may each be essential to the present invention, individually or in any combination.

### BRIEF DESCRIPTION OF THE DRAWINGS

FIG. 1 shows a method, computer program, a storage medium and apparatus according to example embodiments of the present invention.

FIG. 2 shows a schematic diagram of a distributed system according to example embodiments of the present invention.

### DETAILED DESCRIPTION OF EXAMPLE EMBODIMENTS

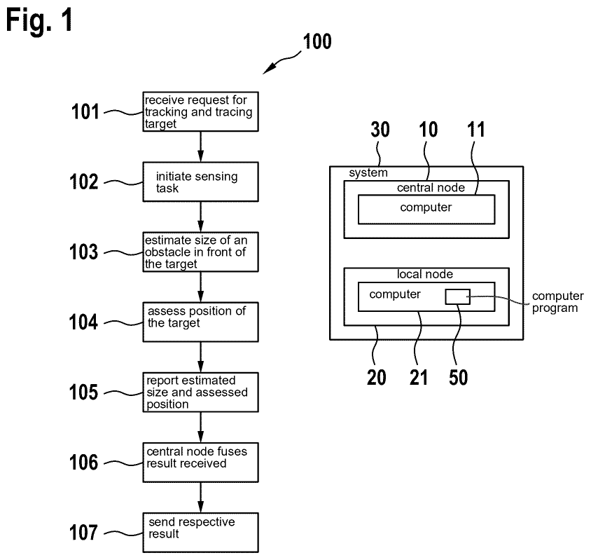

FIG. 1 shows a method 100, a system 30 comprising a central node 10 and a local node 20, and a computer program 50 according to embodiments of the present invention.

FIG. 1 particularly shows an embodiment of a method 100 for a method 100 for tracking and tracing a target 5 in an environment 1. The method 100 comprises the following steps by a distributed ISAC system 30:

In a step 101 a request for tracking and tracing the target 5 in the environment 1 is received from a requesting entity at a central node 10 of the ISAC system 30.

At step 102 a performance of a sensing task is initiated at least one local node 20 of the ISAC system 30 via forwarding the received request from the central node 10 to the at least one local node 20. Then in step 103 the at least one local node 20 estimates a size of an obstacle 4 in front of the target 5 depending on a distortion of the reflected sensing signal caused by an obstacle 4 in front of the target 5 in the environment 1.

At step 104 the at least one local node 20 assesses a position of the target 5 based on the reflection of sensing signals and based on the distortion of the reflected signal caused by the obstacle 4 in front of the target 5. In a next step 105 a report of the respective estimated size of the obstacle 4 and the respective assessed position of the target 5 is transmitted from the at least one local node 20 to the central node 10.

At step 106 the central node 10 fuses the respective result received from the at least one local node 20 to determine the actual location of the target 5 and the size of the one or more obstacles 4. In step 107 the respective result regarding the request is sent via a report to the requesting entity.

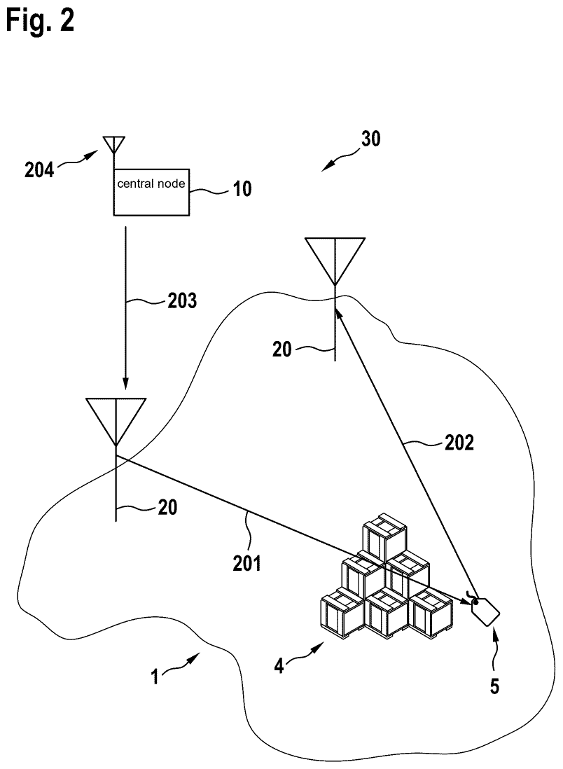

FIG. 2 depicts a schematic diagram of a distributed system according to embodiments of the present invention. In particular, FIG. 2 shows a system 30 comprising a central node 10 and a local node 20. A part of the system 30, in particular at least one local node 20, can be located in an environment 1 of the target 5. The system 30 may be provided as a Distributed Integrated Sensing and Communication (DISAC) system as illustrated in FIG. 2. The DISAC system 30 may comprise at least one local node 20 or one or more local nodes.

The central node 10 can comprise a Sensing Management Function of a communications network or a base station or a DISAC node or another communications network function. The at least one local node 20 can comprise a base station or a DISAC node. The at least one local DISAC node 20 and the central DISAC node 10 can be communicatively connected to send and receive a message or a report or the like in a communications network.

As illustrated in FIG. 2 the at least one node 20 performs a sensing task by sending 201 a sensing signal to a target 5. This performance is initiated 203 by the central node 10 and based on receiving 204 a request to track and trace the target 5 from a requesting entity (not shown in FIG. 2). The at least one local node 20 can receive 202 a distorted signal as a reflection of the sent 201 sensing signal.

A main aspect of the present invention as depicted in FIG. 1 and FIG. 2 lies in the usage of radio waves, particularly from a local node 20 such as a base station capable of sensing. The ISAC system 30 intends on using sensing or ISAC signals as “X-rays” for detecting targets.

The one or more local ISAC nodes receive 202 the reflection of the sensing signals and identify the target 5 or as depicted in FIG. 2 a tag of the target. Then a width of the one or more obstacles 4 in front of the target 5 are estimated by the one or more local DISAC nodes 20 from the distortion of the reflected signal. The one or more local DISAC nodes 20 then can also estimate the position of the target 5. After this the one or more local ISAC nodes 20 can transmit or send a report comprising the estimated position and the estimated width of the shadowing one or more obstacles 4. The central node, in particular central DISAC node 10, can collect the report and fuse the information for further processing. The central DISAC node 10 may send the result comprising for example the target location to the requesting entity. This process can be performed iteratively in case of a moving target 5, initiating or entering into a tracking mode with regular position report.

Further, the present invention can leverage the capability of the system 30 using a distortion of a reflected signal from the target 5 such as for example a radio tag to perceive the depth of obstructing objects 4, or the width of attenuating material 4 in front of the target 5. From this information, the location of the target can be estimated. Such a capability can be particularly interesting in an environment 1 such as a factory or a warehouse, where the material 4 from which infrastructure and boxes are made is well known.

Advantageously, the attenuation coefficient of the known material 4 at the sensing signal frequency is deduced. As a result, the system 30 can calculate the width of the obstructing object 4 from the signal attenuation.

The above explanation of the embodiments describes the present invention in the context of examples. Of course, individual features of the embodiments can be freely combined with each other, provided that this is technically reasonable, without leaving the scope of the present invention.

What is claimed is:

1. A method for tracking and tracing a target in an environment, comprising the following steps performed by a distributed Integrated Sensing and Communication (ISAC) system:
receiving at a central node of the distributed ISAC system, a request for tracking and tracing the target in the environment, from a requesting entity;
initiating a performance of a sensing task by at least one local node of the ISAC system via forwarding the received request from the central node to the at least one local node, wherein the performance of the sensing task includes transmitting a sensing signal;
estimating, by the at least one local node, a size of an obstacle in front of the target depending on a distortion of a reflected sensing signal of the transmitted sensing signal caused by the obstacle in front of the target in the environment;
assessing, by the at least one local node, a position and a size of the target based on reflections of the sensing signal and based on the distortion of the reflected signal caused by the obstacle in front of the target;
transmitting a report of the assessed size of the obstacle and the assessed position of the target from the at least one local node to the central node;
fusing, by the central node, the report received from the at least one local node to determine an actual location of the target and an actual size of the obstacle; and
sending a result of the fusing via a report to the requesting entity for tracking and tracing the target.

2. The method of claim 1, wherein the method steps are carried out iteratively in case of a moving target, and wherein the method further comprises the following step:
sending a position report from the central node to the requesting entity regularly, at defined time points and/or time intervals.

3. The method of claim 1, wherein after the receiving, the following further step is performed:
forwarding the request to at least one local node in the environment of the target.

4. The method of claim 1, wherein during the initiating, at least one of the following further steps is performed:
sending the sensing signal to the target in the environment;
receiving the reflection of the sensing signal from the target.

5. The method of claim 1, wherein the central node includes a Sensing Management Function of a communications network and wherein the at least one local node includes a base station of the communications network.

6. The method of claim 1, wherein the target includes a radio tag, wherein the radio tag reflects a signal in case of receiving the sensing signal.

7. A central node for tracking and tracing a target in an environment, the central node being in a distributed Integrated Sensing and Communication (ISAC) system, the central node being configured to:
receive a request for tracking and tracing the target in the environment, from a requesting entity;
initiate a performance of a sensing task by at least one local node of the ISAC system via forwarding the received request from the central node to the at least one local node, wherein the performance of the sensing task includes transmitting a sensing signal, wherein the at least one local node estimates a size of an obstacle in front of the target depending on a distortion of a reflected sensing signal of the transmitted sensing signal caused by the obstacle in front of the target in the environment, assesses a position and a size of the target based on reflections of the sensing signal and based on the distortion of the reflected signal caused by the obstacle in front of the target, and transmits a report of the assessed size of the obstacle and the assessed position of the target to the central node;
fuse the report received from the at least one local node to determine an actual location of the target and an actual size of the obstacle; and
send a result of the fusing via a report to the requesting entity for tracking and tracing the target.

8. A local node for tracking and tracing a target in an environment, wherein the local node is in a distributed Integrated Sensing and Communication (ISAC) system, the local node being configured to:
perform a sensing task via receiving a forwarded request from a central node of the ISAC system, wherein the performance of the sensing task includes transmitting a sensing signal, the request being a request for tracking and tracing the target in the environment, which was received at the central node from a requesting entity;
estimate a size of an obstacle in front of the target depending on a distortion of a reflected sensing signal of the transmitted sensing signal caused by the obstacle in front of the target in the environment;
assess a position and a size of the target based on reflections of the sensing signal and based on the distortion of the reflected signal caused by the obstacle in front of the target; and
transmit a report of the assessed size of the obstacle and the assessed position of the target from the at least one local node to the central node;
wherein the central node fuses the report received from the local node to determine an actual location of the target and an actual size of the obstacle, and sends a result of the fusing via a report to the requesting entity for tracking and tracing the target.

9. A system for tracking and tracing a target in an environment comprising:
a central node a distributed Integrated Sensing and Communication (ISAC) system; and
at least one local node of the ISAC system;
wherein:
the central node is configured to receive a request for tracking and tracing the target in the environment, from a requesting entity;
the central node is configured to initiate a performance of a sensing task by the at least one local node via forwarding the received request from the central node to the at least one local node, wherein the performance of the sensing task includes transmitting a sensing signal;
the at least one local node is configured to estimate a size of an obstacle in front of the target depending on a distortion of a reflected sensing signal of the transmitted sensing signal caused by the obstacle in front of the target in the environment;
the at least one local node is configured to assess a position and a size of the target based on reflections of the sensing signal and based on the distortion of the reflected signal caused by the obstacle in front of the target;
the at least one local node is configured to transmit a report of the assessed size of the obstacle and the assessed position of the target to the central node;
the central node is configured to fuse the report received from the at least one local node to determine an actual location of the target and an actual size of the obstacle; and
the central node is configured to send a result of the fusing via a report to the requesting entity for tracking and tracing the target.

10. A non-transitory storage medium on which is stored a computer program comprising instructions which, when the program is executed by a computer of a local node of a distributed Integrated Sensing and Communication (ISAC) system, cause the computer to perform the following steps:
performing a sensing task via receiving a forwarded request from a central node of the ISAC system, wherein the performance of the sensing task includes transmitting a sensing signal, the request being a request for tracking and tracing a target in an environment, which was received at the central node from a requesting entity;
estimating a size of an obstacle in front of the target depending on a distortion of a reflected sensing signal of the transmitted sensing signal caused by the obstacle in front of the target in the environment;
assessing a position and a size of the target based on reflections of the sensing signal and based on the distortion of the reflected signal caused by the obstacle in front of the target; and
transmitting a report of the assessed size of the obstacle and the assessed position of the target from the at least one local node to the central node;
wherein the central node fuses the report received from the local node to determine an actual location of the target and an actual size of the obstacle, and sends a result of the fusing via a report to the requesting entity for tracking and tracing the target.
